(19) United States
(12) Patent Application Publication
(10) Pub. No.: US 2025/0259244 A1
(43) Pub. Date: Aug. 14, 2025

(54) REAL-TIME HAZARD-BASED NAVIGATIONAL SYSTEM AND DATABASE

(71) Applicant: Allstate Insurance Company, Northbrook, IL (US)

(72) Inventor: Sunil Chintakindi, Naperville, IL (US)

(21) Appl. No.: 19/169,598

(22) Filed: Apr. 3, 2025

Related U.S. Application Data
(63) Continuation of application No. 15/154,247, filed on May 13, 2016, now abandoned.

(51) Int. Cl. G06Q 40/08; B60W 40/09; G01C 21/36; G06Q 30/08

(52) U.S. Cl. CPC G06Q 40/08; B60W 40/09; G01C 21/3691; G06Q 30/08

(57) ABSTRACT

Methods, computer-readable media, systems and apparatuses for determining and implementing hazard unit based insurance policies are presented. A user may input a preliminary navigational route. The preliminary navigational route may be parsed into a plurality of road segments. Sensor data may be received from one or more databases. The sensor data may provide information associated with driving behaviors of the user, environmental conditions of the routes on which the vehicle has traveled, and the like. A road segment hazard score may be calculated for each road segment based in part on the sensor data. A total route hazard score may be calculated based on the road segment hazard score calculated for each road segment. The total route segment score may be transmitted to a real-time vehicular service exchange. One or more bids may be received from one or more computing devices of the real-time vehicular service exchange. A bid from the one or more received bids may be selected to insure the vehicle as it travels along the preliminary navigational route.

### CROSS-REFERENCE TO RELATED APPLICATIONS

The present application is a continuation of and claims priority to U.S. patent application Ser. No. 15/154,247 filed on May 13, 2016, which is incorporated by reference in its entirety herein.

### TECHNICAL FIELD

Various aspects of the disclosure relate to navigational systems for route searching using a map database system.

### BACKGROUND

Many vehicles include sensors and internal computer systems designed to store and monitor driving data, vehicle operational data, driving conditions, and driving functions. Many vehicles also include one or more communication systems designed to send and receive information from inside or outside the vehicle. Such information can include, for example, vehicle operational data, driving conditions, and communications from other vehicles or systems. This information may be used to determine costs associated with operating a vehicle, particular routes, and the like.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

The present disclosure is directed to navigational systems for route searching using a map database system. A user may input a request into a user interface for a route from a current location to a destination. The navigational system may generate a predetermined route based on the user input. The navigational system may analyze the predetermined route to generate a hazard score for the predetermined route. The navigational system may consider real-time conditions, such as traffic and weather, when analyzing the predetermined route. The hazard score may be transmitted to one or more service providers via a route-based vehicular servicing exchange system. If the hazard score is above a threshold or if the service providers indicate that the hazard score is too high, route modification may be performed. The navigational system may consider real-time conditions, such as traffic and weather, when performing route modification. Performing route modification may include generating a new route from a current location to a destination. The new route may have a lower hazard score than the predetermined route. The new route may be presented to the user via the user interface.

Aspects of the disclosure relate to methods, computer-readable media, and apparatuses for receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, calculating a total route hazard score based on the road segment hazard score calculated for each road segment of the plurality of road segments, transmitting the total route hazard score to a first computing device and a second computing device, receiving, from the first computing device, a first bid to insure the preliminary navigational route for a first premium amount, receiving, from the second computing device, a second bid to insure the preliminary navigational route for a second premium amount, and selecting one of the first bid and the second bid. In some examples, selecting one of the first bid and the second bid may include sending the first bid and the second bid to the driver of the vehicle and receiving a selection from the driver, the selection indicating one of the first bid and the second bid. Aspects of the disclosure are further directed to sending the total route hazard score to a third computing device, receiving a third bid to insure a first potential alternate navigational route that has a first total route hazard score below a first value for a third premium amount, determining whether a first alternate route that has a first total route hazard score below the first value can be generated, and responsive to a determination that a first alternate route that has a first total route hazard score below the first value can be generated, sending the first alternate route and the third premium amount to the driver of the vehicle. Aspects of the disclosure are further directed to receiving a fourth bid to insure a second potential alternate navigational route that has a second total route hazard score below a second value for a fourth premium amount, determining whether a second alternate route that has a second total route hazard score below the second value can be generated, and responsive to a determination that a second alternate route that has a second total route hazard score below the second value cannot be generated, not sending the second alternate route and the fourth premium amount to the driver of the vehicle. In some examples, selecting one of the first bid and the second bid may include automatically selecting the first bid responsive to determining that the first premium amount is less than the second premium amount. In some examples, selecting one of the first bid and the second bid may include automatically selecting the first bid responsive to determining that a service provider associated with the first computing device is a preferred service provider. Calculating the total route hazard score may include calculating an average of each of the road segment hazard scores and adjusting the average responsive to a determination that a number of road segments having road segment hazard scores above a threshold exceeds a first value

Aspects of the disclosure relate to methods, computer-readable media, and apparatuses for receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, transmitting the road segment hazard score calculated for each road segment of the plurality of road segments to a plurality of computing devices, and for each road segment of the plurality of road segments: responsive to a determination that no bid is received from the plurality of computing devices for that road segment, selecting a default service provider for that road segment, and responsive to a determination that one or more bids have been received from the plurality of computing devices for that road segment, selecting a first bid from the one or more bids for that road segment. In some examples, selecting a bid from the one or more bids may include sending the one or more bids to the driver of the vehicle and receiving a selection of the first bid from the one or more bids. In some examples, selecting the first bid may include automatically selecting the first bid responsive to determining that a first premium amount associated with the first bid of the one or more bids is less than a second premium amount associated with a second bid of the one or more bids. In some examples, selecting the first bid may include automatically selecting the first bid responsive to determining that a service provider associated with the first bid is a preferred service provider.

Other features and advantages of the disclosure will be apparent from the additional description provided herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates computing systems and a network environment that may be used to implement aspects of the disclosure.

FIG. 2 is an example real-time hazard-based insurance system according to one or more aspects described herein.

FIG. 3 is an example real-time hazard-based insurance system environment illustrating various communications between vehicles-based devices, a personal mobile device, and an insurance system server, according to one or more aspects of the disclosure.

FIG. 4 is a flow diagram illustrating an example method of calculating a hazard score for a navigational route according to one or more aspects described herein.

FIG. 5 is an example real-time vehicular service exchange within a real-time hazard-based insurance system according to one or more aspects described herein.

FIG. 6 is a flow diagram illustrating an example method for insuring a preliminary navigational route based on a total route hazard score via a real-time hazard-based insurance system, according to one or more aspects described herein.

FIG. 7 is a flow diagram illustrating an example method for insuring a preliminary navigational route based on individual hazard scores for road segments via a real-time hazard-based insurance system, according to one or more aspects described herein.

FIG. 8 is an example user interface providing one or more bids and notifications to a user, according to one or more aspects described herein.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer-readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Vehicle insurance policies are generally purchased by insurance customers from various insurance providers. Conventional policies generally provide coverage to the user for a term of the policy based on payment of a premium associated with the policy. Such term based policies might not account for the routes to be traveled by the customers, the driving behaviors of the customers, environmental conditions when the customer is traveling, or the like. Rather, coverage may be provided for the term, regardless of how, where, when, etc. the driver operates the vehicle.

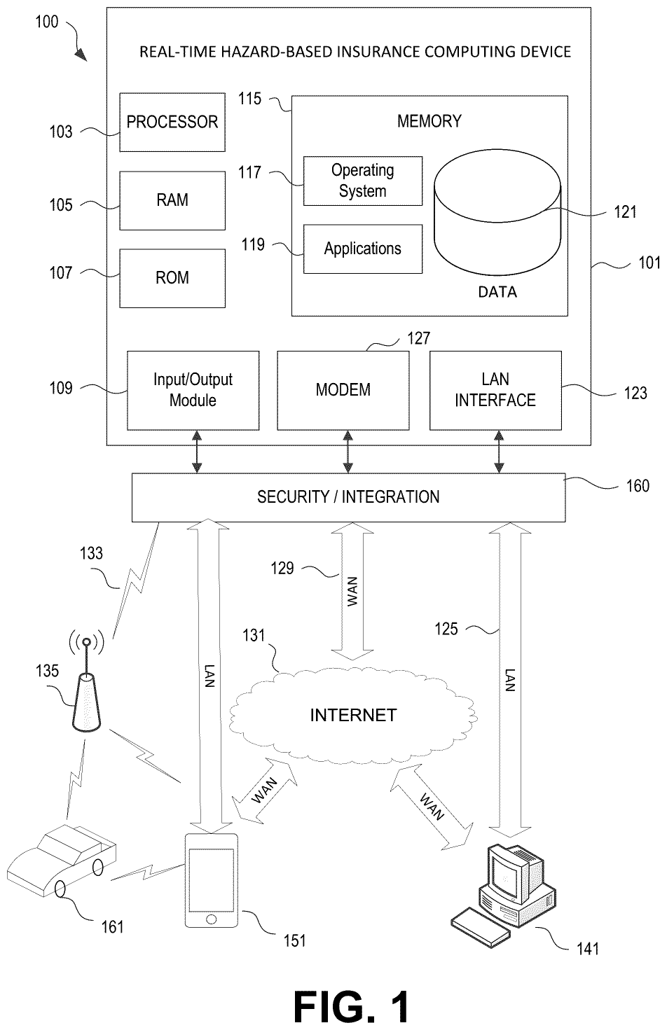

FIG. 1 illustrates a block diagram of a real-time hazard-based insurance computing device (or system) 101 in a hazard unit based insurance system 100 that may be used according to one or more illustrative embodiments of the disclosure. The real-time hazard-based insurance computing device 101 may have a processor 103 for controlling overall operation of the real-time hazard-based insurance computing device 101 and its associated components, including RAM 105, ROM 107, input/output module 109, and memory 115. The real-time hazard-based insurance computing device 101, along with one or more additional devices (e.g., terminals 141 and 151, security and integration hardware 160) may correspond to any of multiple systems or devices described herein, such as personal mobile devices, vehicle-based computing devices, insurance systems servers, external data sources and other various devices in a hazard unit based insurance system. These various computing systems may be configured individually or in combination, as described herein, for receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, calculating a total route hazard score based on the road segment hazard score calculated for each road segment of the plurality of road segments, transmitting the total route hazard score to a first computing device and a second computing device, receiving, from the first computing device, a first bid to insure the preliminary navigational route for a first premium amount, receiving, from the second computing device, a second bid to insure the preliminary navigational route for a second premium amount, selecting one of the first bid and the second bid, and the like, using the devices of the real-time hazard-based insurance systems described herein. In addition to the features described above, the techniques described herein also may be used for generating and presenting insurance recommendations to customers, insurance underwriting, and other insurance-related tasks.

Input/Output (I/O) 109 may include a microphone, keypad, touch screen, and/or stylus through which a user of the real-time hazard-based insurance computing device 101 may provide input, and may also include one or more of a speaker for providing audio output and a video display device for providing textual, audiovisual and/or graphical output. Software may be stored within memory 115 and/or storage to provide instructions to processor 103 for enabling real-time hazard-based insurance computing device 101 to perform various actions. For example, memory 115 may store software used by the real-time hazard-based insurance device 101, such as an operating system 117, application programs 119, and an associated internal database 121. The various hardware memory units in memory 115 may include volatile and nonvolatile, removable and non-removable media implemented in any method or technology for storage of information such as computer-readable instructions, data structures, program modules or other data. Certain devices and systems within hazard unit based insurance systems may have minimum hardware requirements in order to support sufficient storage capacity, processing capacity, analysis capacity, network communication, etc. For instance, in some embodiments, one or more nonvolatile hardware memory units having a minimum size (e.g., at least 1 gigabyte (GB), 2 GB, 5 GB, etc.), and/or one or more volatile hardware memory units having a minimum size (e.g., 256 megabytes (MB), 512 MB, 1 GB, etc.) may be used in a real-time hazard-based insurance computing device 101 (e.g., a personal mobile device 151, vehicle-based device 161, insurance system server 141, etc.), in order to receive a preliminary navigational route, parse the preliminary navigational route into a plurality of road segments, receive, from at least one sensor arranged on a vehicle, driving data associated with a driver of the vehicle or the preliminary navigational route, calculate, for each road segment of the plurality of road segments and based in part on the driving data, a road segment hazard score, calculate a total route hazard score based on the road segment hazard score calculated for each road segment of the plurality of road segments, transmit the total route hazard score to a first computing device and a second computing device, receive, from the first computing device, a first bid to insure the preliminary navigational route for a first premium amount, receive, from the second computing device, a second bid to insure the preliminary navigational route for a second premium amount, and select one of the first bid and the second bid, etc., using the various devices of the hazard unit based insurance systems. Memory 115 also may include one or more physical persistent memory devices and/or one or more non-persistent memory devices. Memory 115 may include, but is not limited to, random access memory (RAM) 105, read only memory (ROM) 107, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Processor 103 may include a single central processing unit (CPU), which may be a single-core or multi-core processor (e.g., dual-core, quad-core, etc.), or may include multiple CPUs. Processor(s) 103 may have various bit sizes (e.g., 16-bit, 32-bit, 64-bit, 96-bit, 128-bit, etc.) and various processor speeds (ranging from 100 MHz to 5 Ghz or faster). Processor(s) 103 and its associated components may allow the real-time hazard-based insurance computing system 101 to execute a series of computer-readable instructions, for example, receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, calculating a total route hazard score based on the road segment hazard score calculated for each road segment of the plurality of road segments, transmitting the total route hazard score to a first computing device and a second computing device, receiving, from the first computing device, a first bid to insure the preliminary navigational route for a first premium amount, receiving, from the second computing device, a second bid to insure the preliminary navigational route for a second premium amount, and selecting one of the first bid and the second bid.

The computing device (e.g., a personal mobile device, vehicle-based system, insurance system server, etc.) may operate in a networked hazard unit based insurance system 100 supporting connections to one or more remote computers, such as terminals 141, 151, and 161. Such terminals may be personal computers or servers 141 (e.g., home computers, laptops, web servers, database servers), mobile communication devices 151 (e.g., mobile phones, tablet computers, etc.), vehicle-based computing systems 161 (e.g., on-board vehicle systems, telematics devices, mobile phones or other personal mobile devices within vehicles), and the like, each of which may include some or all of the elements described above with respect to the real-time hazard-based insurance computing device 101. The network connections depicted in FIG. 1 include a local area network (LAN) 125 and a wide area network (WAN) 129, and a wireless telecommunications network 133, but may also include other networks. When used in a LAN networking environment, the real-time hazard-based insurance computing device 101 may be connected to the LAN 125 through a network interface or adapter 123. When used in a WAN networking environment, the real-time hazard-based insurance computing device 101 may include a modem 127 or other means for establishing communications over the WAN 129, such as network 131 (e.g., the Internet). When used in a wireless telecommunications network 133, the device 101 may include one or more transceivers, digital signal processors, and additional circuitry and software for communicating with wireless computing devices 151 and 161 (e.g., mobile phones, portable customer computing devices, vehicle-based computing devices and systems, etc.) via one or more network devices 135 (e.g., base transceiver stations) in the wireless network 133.

Also illustrated in FIG. 1 is a security and integration layer 160, through which communications are sent and managed between the real-time hazard-based insurance computing device 101 (e.g., a personal mobile device, a vehicle-based computing device, an insurance server, an intermediary server and/or external data source servers, etc.) and the remote devices (141, 151, and 161) and remote networks (125, 129, and 133). The security and integration layer 160 may comprise one or more separate computing devices, such as web servers, authentication servers, and/or various networking components (e.g., firewalls, routers, gateways, load balancers, etc.), having some or all of the elements described above with respect to the real-time hazard-based insurance computing device 101. As an example, a security and integration layer 160 of a real-time hazard-based insurance computing device 101 may comprise a set of web application servers configured to use secure protocols and to insulate the real-time hazard-based insurance computing device 101 from external devices 141, 151, and 161. In some cases, the security and integration layer 160 may correspond to a set of dedicated hardware and/or software operating at the same physical location and under the control of same entities as real-time hazard-based insurance computing device 101. For example, layer 160 may correspond to one or more dedicated web servers and network hardware in a vehicle and driver information datacenter or in a cloud infrastructure supporting a cloud-based vehicle identification and vehicle and driver data retrieval and analysis. In other examples, the security and integration layer 160 may correspond to separate hardware and software components which may be operated at a separate physical location and/or by a separate entity.

As discussed below, the data transferred to and from various devices in a hazard unit based insurance system 100 may include secure and sensitive data, such as confidential vehicle operation data, insurance policy data, and confidential user data from drivers and passengers in vehicles. Therefore, it may be desirable to protect transmissions of such data by using secure network protocols and encryption, and also to protect the integrity of the data when stored on the various devices within a personalized insurance system, such as personal mobile devices, vehicle-based devices, insurance servers, external data source servers, or other computing devices in the hazard unit based insurance system 100, by using the security and integration layer 160 to authenticate users and restrict access to unknown or unauthorized users. In various implementations, security and integration layer 160 may provide, for example, a file-based integration scheme or a service-based integration scheme for transmitting data between the various devices in a hazard unit based insurance system 100. Data may be transmitted through the security and integration layer 160, using various network communication protocols. Secure data transmission protocols and/or encryption may be used in file transfers to protect to integrity of the data, for example, File Transfer Protocol (FTP), Secure File Transfer Protocol (SFTP), and/or Pretty Good Privacy (PGP) encryption. In other examples, one or more web services may be implemented within the various devices in the hazard unit based insurance system 100 and/or the security and integration layer 160. The web services may be accessed by authorized external devices and users to support input, extraction, and manipulation of the data (e.g., vehicle data, driver data, driving trip data, etc.) between the various devices in the hazard unit based insurance system 100. Web services built to support a personalized display system may be cross-domain and/or cross-platform, and may be built for enterprise use. Such web services may be developed in accordance with various web service standards, such as the Web Service Interoperability (WS-I) guidelines. In some examples, a driver data, vehicle data, and/or driving trip data analysis web service, a hazard unit based insurance policy determination or offer web service, or the like, may be implemented in the security and integration layer 160 using the Secure Sockets Layer (SSL) or Transport Layer Security (TLS) protocol to provide secure connections between real-time hazard-based insurance computing device 101 and various clients 141, 151, and 161. SSL or TLS may use HTTP or HTTPS to provide authentication and confidentiality. In other examples, such web services may be implemented using the WS-Security standard, which provides for secure SOAP messages using XML encryption. In still other examples, the security and integration layer 160 may include specialized hardware for providing secure web services. For example, secure network appliances in the security and integration layer 160 may include built-in features such as hardware-accelerated SSL and HTTPS, WS-Security, and firewalls. Such specialized hardware may be installed and configured in the security and integration layer 160 in front of the web servers, so that any external devices may communicate directly with the specialized hardware.

Although not shown in FIG. 1, various elements within memory 115 or other components in system 100, may include one or more caches, for example, CPU caches used by the processing unit 103, page caches used by the operating system 117, disk caches of a hard drive, and/or database caches used to cache content from database 121. For embodiments including a CPU cache, the CPU cache may be used by one or more processors in the processing unit 103 to reduce memory latency and access time. In such examples, a processor 103 may retrieve data from or write data to the CPU cache rather than reading/writing to memory 115, which may improve the speed of these operations. In some examples, a database cache may be created in which certain data from a database 121 (e.g., a database of driver data, driving behaviors or characteristics, passenger-related data, vehicle data, driving trip data, account balance data, etc.) is cached in a separate smaller database on an application server separate from the database server (e.g., at a personal mobile device, vehicle-based data, or intermediary network device or cache device, etc.). For instance, in a multi-tiered application, a database cache on an application server can reduce data retrieval and data manipulation time by not needing to communicate over a network with a back-end database server. These types of caches and others may be included in various embodiments, and may provide potential advantages in certain implementations of hazard unit based insurance systems, such as faster response times and less dependence on network conditions when transmitting and receiving driver information, vehicle information, driving trip information, insurance parameters, account balance information, and the like.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computing devices in hazard unit based insurance system components described herein may be configured to communicate using any of these network protocols or technologies.

Additionally, one or more application programs 119 may be used by various real-time hazard-based insurance computing device 101 within a hazard unit based insurance system 100 (e.g., vehicle data, driver data, and/or driving trip data analysis software applications, insurance parameter determination software applications, hazard unit account applications, etc.), including computer executable instructions for receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, calculating a total route hazard score based on the road segment hazard score calculated for each road segment of the plurality of road segments, transmitting the total route hazard score to a first computing device and a second computing device, receiving, from the first computing device, a first bid to insure the preliminary navigational route for a first premium amount, receiving, from the second computing device, a second bid to insure the preliminary navigational route for a second premium amount, and selecting one of the first bid and the second bid.

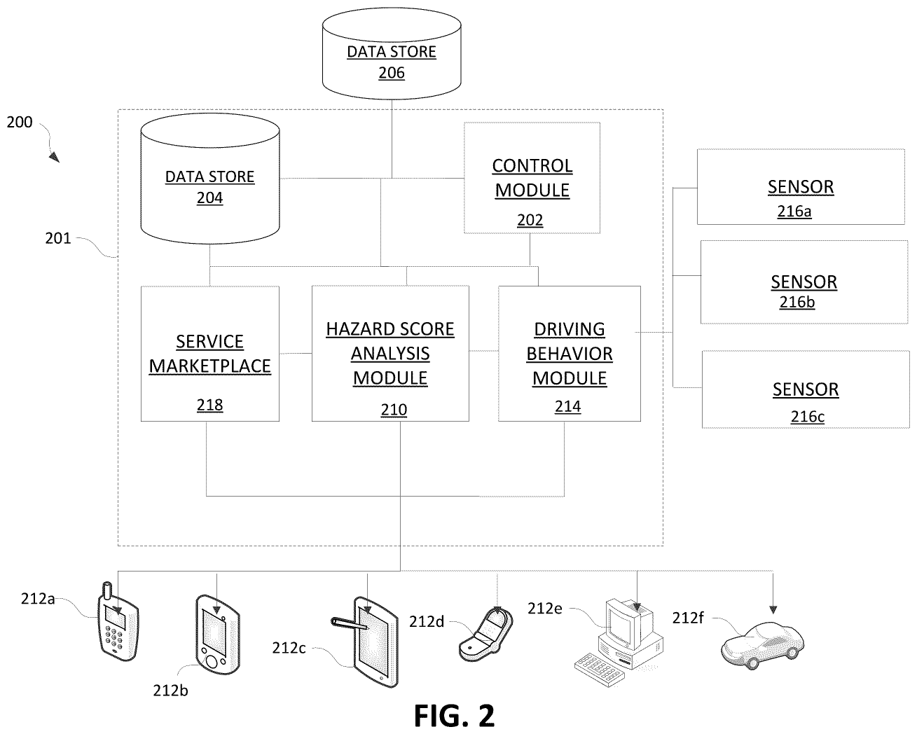

FIG. 2 is a schematic diagram of an illustrative real-time hazard-based insurance system 200. The real-time hazard-based insurance system 200 may be associated with, internal to, operated by, or the like, an entity 201, such as an insurance provider. In some examples, the entity may be one of various other types of entities, such as a government entity, corporation or business, university, or the like. Various examples described herein will be discussed in the context of an insurance provider. However, nothing in the specification should be viewed as limiting use of the systems, methods, arrangements, etc. described herein to use only by an insurance provider.

The real-time hazard-based insurance system 200 may include one or more modules that may include hardware and/or software configured to perform various functions within the real-time hazard-based insurance system 200. The one or more modules may be separate, physical devices or, in other examples, one or more modules may be part of the same physical device.

The real-time hazard-based insurance system 200 may include a control module 202. Control module 202 may be configured to receive a preliminary navigational route that a driver plans on traveling or on which a driver is currently traveling. For example, the preliminary navigational route may be received from the user via a computing device, such as one or more of computing devices 212a-212f. For instance, the preliminary navigational route may be received via an application (e.g., online or mobile application) executing on a smartphone 212a, personal digital assistant (PDA) 212b, tablet 212c, cell phone 212d, or other computing device 212e. In some examples, the preliminary navigational route may be input by a user on vehicle display 212f and transmitted to control module 202. Control module 202 may transmit the preliminary navigational route to a hazard score analysis module 210. The hazard score analysis module 210 may parse the preliminary navigational route into one or more road segments. The hazard score analysis module 210 may receive data from one or more data stores, such as data stores 204 and 206, and may determine a hazard score for each of the one or more road segments based on the received data. In some examples, a road segment may be some or all of a particular road. The road segments may have varying lengths or distances, may be formed of various materials, may include various types of roads (e.g., highway, country road, etc.), and the like.

As indicated above, at least some of the data used to determine the road segment hazard score may be received from one or more data stores. The data stores may be associated with or internal to the entity 201, such as data store 204, or may be external to the entity 201, such as data store 206. Data that may be used to determine a road segment hazard score may include historical accident information associated with a particular road segment, traffic volume information associated with a particular road segment, severity of accident associated with a particular road segment (e.g., based on previously received insurance claim data), and the like. In some examples, geocoded data may be received by the real-time hazard-based insurance system 200 (e.g., from data store 206) and may be used to determine a hazard score for one or more road segments. In some arrangements, additional information such as type of road segment (2-lane highway, 4-lane highway, rural road, etc.), condition of road segment (e.g., newly resurfaced, severely damaged, etc.), and the like (as discussed above), may be used to determine the road segment hazard score.

Accordingly, some information may be received by the hazard score analysis module 210 from internal data store 204. The internal data store 204 may include information associated with accidents associated with the road segment, accidents associated with that type of road or one or more features of the road segment (e.g., number of bends, merging, etc.), severity of accidents associated with the road segment (e.g., based on insurance claim data), number of accidents associated with the road segment, time of day of accident, date of accident, and the like. Accident information received from internal data store 204 may be collected from historical accident or claim information of the insurance provider entity 201. The internal data store 204 may also include information associated with conditions of the road segment (e.g., pot holes, type of road, etc.). In some arrangements, this information may be received from a telematics device associated with one or more vehicles, and associated sensors detecting such information. The received telematics data may be stored and used to determine, for example, a road segment hazard score.

External data store 206 may provide additional information to the real-time hazard-based insurance system 200. For instance, external data store may provide additional information associated with the type of road, condition of the road, etc. Further, external data store 206 may include information gathered from various sources regarding accidents associated with the road segment, traffic volume associated with the road segment, and the like. As discussed above, the accident information may be received from a third party and/or coded to identify the road segment, type of accident, severity of accident, and the like. In some examples, external data store 206 may include information associated with environmental or weather conditions surrounding a road segment. Accordingly, a road segment hazard score may be generated in real-time, or near real-time, and may include current weather conditions (e.g., rain, snow, fog, etc.) and current traffic conditions. Some example algorithms that may be used to determine a road segment hazard score are provided below. The example algorithms provided are merely examples and various other algorithms may be used to determine road segment hazard score without departing from the invention.

The hazard score analysis module 210 may detect a location of a vehicle (e.g., via global positioning system (GPS) data collected from the vehicle) and may identify a road segment associated with the location of the vehicle. This identification of the road segment may be performed by comparing the location coordinates from the vehicle to location coordinates of roads obtained, for example, from a mapping company or from analysis of many vehicles' location coordinates over time. The hazard score analysis module 210 may then receive data from various data stores, such as data store 204 and/or data store 206, and may generate a road segment hazard score for the identified road segment.

The road segment hazard score may be generated by the hazard score analysis module 210 based on data associated with the road segment, as discussed above, as well as data associated with a driver of the vehicle. For instance, driver-specific data may be received by the hazard score analysis module 210 and may be used in conjunction with the various types of data discussed above, to determine a road segment hazard score for a particular road segment. For instance, the real-time hazard-based insurance system 200 may include a plurality of sensors 216a-216c. The sensors 216a-216c may be any of various types of sensors, as will be discussed more fully herein. The sensors 216a-216c may be used to obtain data associated with driving behaviors of the user, such as hard braking, speeding, swerving, rapid acceleration, and the like. In another example, one or more sensors may be used to detect environmental conditions such as precipitation, humidity, cloud cover, or the like. In still another example, one or more sensors may be used to determine road conditions or to obtain information from outside sources (e.g., external databases, or the like) regarding traffic conditions, types of road (e.g., two-lane road, four-lane road), speed limit of the road, or the like. The data from one or more sensors 216a-216c, which may include data from combinations of different types of sensors, may be transmitted to driving behavior module 214 for analysis.

The driving behavior module 214 may analyze sensor data received from one or more of sensors 216a-216c and may identify one or more driving behaviors of a particular driver or operator of the vehicle. For instance, the driving behavior module 214 may determine whether the user generally drives at a speed over the speed limit, generally follows too closely behind a vehicle in front of him, generally brakes hard, and the like. This information may be transmitted to the hazard score analysis module 210 for use in determining a hazard score for a particular road segment.

In some arrangements, raw sensor data (e.g., from one or more of sensors 216a-216c) may be used in conjunction with other data (e.g., from data store 204, 206) to generate the road segment hazard score. For instance, one or more sensors may be used to detect precipitation. That information may be provided to the hazard score analysis module 210 in real-time, or near real-time, and may be combined with other data (e.g., accident data, traffic volume data, etc.) for the road segment, and/or user driving behavior data, to generate or determine the road segment hazard score for the road segment. In some examples, based on this real-time or near real-time data, any hazards identified (e.g., hazards appearing along the route being travelled) may be transmitted to the user, via an audible warning or alert displayed on a computing device, such as an on-board vehicle computing device, mobile device of the user, etc. The hazards may be unique to the driver based on driving characteristic data collected for the user, as well as current external or environmental conditions.

The road segment hazard score may be transmitted to a computing device of a user, such as one or more of computing devices 212a-212f. For instance, the road segment hazard score may be transmitted to a smart phone 212a, personal digital assistance 212b, tablet computing device 212c, cell phone 212d, on-board vehicle computing device 212f, or other computing device 212e.

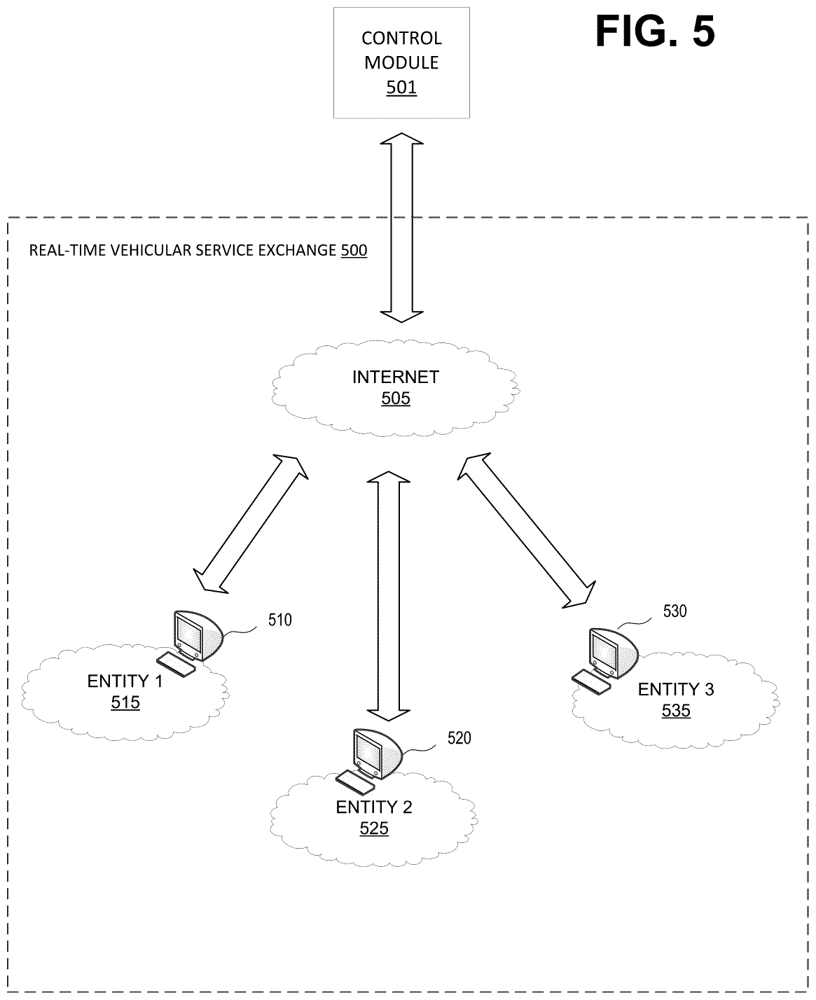

In one arrangement, the hazard score analysis module 210 may calculate a total route hazard score for the preliminary navigational route based on the hazard scores for each of the road segments that make up the preliminary navigational route. The hazard score analysis module 210 may then transmit the total route hazard score to service marketplace module 218 either directly or via control module 202. Service marketplace module 218 may include a real-time vehicular service exchange. The real-time vehicular service exchange (discussed in detail below in reference to FIGS. 5-7) may comprise one or more computing devices. Each of the computing devices may be associated with a different entity, such as an insurance provider. Each of the one or more computing devices may be configured to receive the total route hazard score from the hazard score analysis module 210 or control module 202. Each of the one or more computing devices may further be configured to analyze the total route hazard score and to decide whether to place a bid to insure the vehicle as it travels on the preliminary navigational route. If a computing device decides to place a bid on insuring the vehicle as it travels on the preliminary navigational route, the computing device may further be configured to transmit the bid to control module 202. Additionally, or alternatively, the computing device may decide to place an alternative bid, discussed in detail below. The computing device may further transmit the alternative bid to control module 202. Control module 202 may receive each of the bids placed by the one or more computing devices of service marketplace module 218. Control module 202 may select a bid from the received bids or may transmit the bids to the driver so that the driver may select a bid from the received bids.

In another arrangement, the hazard score analysis module 210 may transmit the hazard score for each road segment to service marketplace module 218 either directly or via control module 202. Each of the one or more computing devices in the real-time vehicular service exchange may be configured to receive hazard scores for each road segment from the hazard score analysis module 210 or control module 202. Each of the one or more computing devices may further be configured to analyze the hazard scores and to decide whether to place a bid on insuring the vehicle as it travels along one or more of the road segments. If a computing device decides to place a bid on insuring the vehicle as it travels along one or more of the road segments, the computing device may further be configured to transmit information identifying the road segments and the premium amount for each road segment to control module 202.

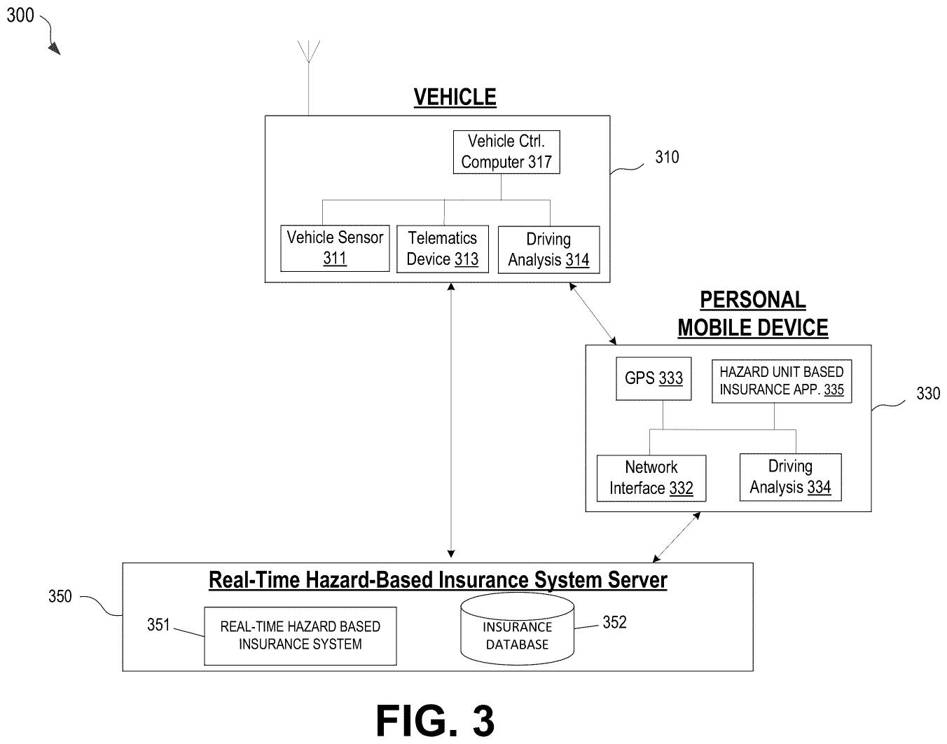

FIG. 3 is a diagram of an illustrative hazard-based driving analysis system 300 including additional aspects of the real-time hazard-based insurance system 200 shown in FIG. 2 and/or implementing the real-time hazard-based insurance system 200 of FIG. 2. The system includes a vehicle 310, a personal mobile device 330, a real-time hazard-based insurance system server 350, and additional related components. As discussed below, the components of the hazard-based driving analysis system 300, individually or using communication and collaborative interaction, may receive a preliminary navigational route, parse the preliminary navigational route into a plurality of road segments, receive, from at least one sensor arranged on a vehicle, driving data associated with a driver of the vehicle or the preliminary navigational route, calculate, for each road segment of the plurality of road segments and based in part on the driving data, a road segment hazard score, calculate a total route hazard score based on the road segment hazard score calculated for each road segment of the plurality of road segments, transmit the total route hazard score to a first computing device and a second computing device, receive, from the first computing device, a first bid to insure the vehicle as it travels along the preliminary navigational route for a first premium amount, receive, from the second computing device, a second bid to insure the vehicle as it travels along the preliminary navigational route for a second premium amount, and select one of the first bid and the second bid, etc. To perform such features, the components shown in FIG. 3 each may be implemented in hardware, software, or a combination of the two. Additionally, each component of the hazard-based driving analysis system 300 may include a computing device (or system) having some or all of the structural components described above for computing device 101.

Vehicle 310 in the hazard-based driving analysis system 300 may be, for example, an automobile, a motorcycle, a scooter, a bus, a recreational vehicle, a boat, or other vehicle for which vehicle data, location data, driver data (or operator data), operational data and/or other driving data (e.g., location data, time data, weather data, etc.) may be collected and analyzed. Vehicle 310 may include vehicle control computer 317. Vehicle control computer 317 may include an on-board vehicle computing device having a display arranged, for instance, in a dashboard of the vehicle. The vehicle control computer 317 may be connected to or in communication with one or more systems, sub-systems, or components of the vehicle (e.g., braking control systems, speed control systems, and the like). The vehicle 310 includes vehicle operation sensor 311 (similar to one or more of sensors 216a-216c of FIG. 2) capable of detecting and recording various conditions at the vehicle and operational parameters of the vehicle. For example, sensor 311 may detect and store data corresponding to the vehicle's location (e.g., GPS coordinates), time, travel time, speed and direction, rates of acceleration or braking, gas mileage, and specific instances of sudden acceleration, braking, swerving, and distance traveled. Sensor 311 also may detect and store data received from the vehicle's 310 internal systems, such as impact to the body of the vehicle, air bag deployment, headlights usage, brake light operation, door opening and closing, door locking and unlocking, cruise control usage, hazard lights usage, windshield wiper usage, horn usage, turn signal usage, seat belt usage, phone and radio usage within the vehicle, autonomous driving system usage, maintenance performed on the vehicle, and other data collected by the vehicle's computer systems, including the vehicle on-board diagnostic systems (OBD).

Additional sensors 311 may detect and store the external driving conditions, for example, external temperature, rain, snow, light levels, and sun position for driver visibility. For example, external cameras and proximity sensors 311 may detect other nearby vehicles, vehicle spacing, traffic levels, road conditions, traffic obstructions, animals, cyclists, pedestrians, and other conditions that may factor into a driving data/behavior analysis. Sensor 311 also may detect and store data relating to moving violations and the observance of traffic signals and signs by the vehicle 310. Additional sensors 311 may detect and store data relating to the maintenance of the vehicle 310, such as the engine status, oil level, engine coolant temperature, odometer reading, the level of fuel in the fuel tank, engine revolutions per minute (RPMs), software upgrades, and/or tire pressure.

Vehicles sensor 311 also may include cameras and/or proximity sensors capable of recording additional conditions inside or outside of the vehicle 310. For example, internal cameras may detect conditions such as the number of the passengers and the types of passengers (e.g. adults, children, teenagers, pets, etc.) in the vehicles, and potential sources of driver distraction within the vehicle (e.g., pets, phone usage, and unsecured objects in the vehicle). Sensor 311 also may be configured to collect data identifying a current driver from among a number of different possible drivers, for example, based on driver's seat and mirror positioning, driving times and routes, radio usage, etc. Voice/sound data along with directional data also may be used to determine a seating position within a vehicle 310. Sensor 311 also may be configured to collect data relating to a driver's movements or the condition of a driver. For example, vehicle 310 may include sensors that monitor a driver's movements, such as the driver's eye position and/or head position, etc. Additional sensors 311 may collect data regarding the physical or mental state of the driver, such as fatigue or intoxication. The condition of the driver may be determined through the movements of the driver or through other sensors, for example, sensors that detect the content of alcohol in the air or blood alcohol content of the driver, such as a breathalyzer, along with other biometric sensors.

Certain vehicle sensors 311 also may collect information regarding the driver's route choice, whether the driver follows a given route, and to classify the type of trip (e.g. commute, errand, new route, etc.) and type of driving (e.g., continuous driving, parking, stop-and-go traffic, etc.). In certain embodiments, sensors and/or cameras 311 may determine when and how often the vehicle 310 stays in a single lane or strays into other lane. A Global Positioning System (GPS), locational sensors positioned inside the vehicle 310, and/or locational sensors or devices external to the vehicle 310 may be used to determine the route, speed, lane position, road-type (e.g. highway, entrance/exit ramp, residential area, etc.) and other vehicle position/location data.

The data collected by vehicle sensor 311 may be stored and/or analyzed within the vehicle 310, such as for example a driving analysis computer 314 integrated into the vehicle, and/or may be transmitted to one or more external devices. For example, as shown in FIG. 3, sensor data may be transmitted via a telematics device 313 to one or more remote computing devices, such as personal mobile device 330, real-time hazard-based insurance system server 350, and/or other remote devices.

As shown in FIG. 3, the data collected by vehicle sensor 311 may be transmitted to a real-time hazard-based insurance system server 350, personal mobile device 330, and/or additional external servers and devices via telematics device 313. Telematics device 313 may be one or more computing devices containing many or all of the hardware/software components as the computing device 101 depicted in FIG. 1. As discussed above, the telematics device 313 may receive vehicle operation data and driving data from vehicle sensor 311, and may transmit the data to one or more external computer systems (e.g., real-time hazard-based insurance system server 350 of an insurance company, financial institution, or other entity) over a wireless transmission network. Telematics device 313 also may be configured to detect or determine additional types of data relating to real-time driving and the condition of the vehicle 310. The telematics device 313 also may store the type of vehicle 310, for example, the make, model, trim (or sub-model), year, and/or engine specifications, as well as other information such as vehicle owner or driver information, insurance information, and financing information for the vehicle 310.

In the example shown in FIG. 3, telematics device 313 may receive vehicle driving data from vehicle sensor 311, and may transmit the data to a real-time hazard-based insurance system server 350. However, in other examples, one or more of the vehicle sensors 311 or systems may be configured to receive and transmit data directly from or to a real-time hazard-based insurance system server 350 without using a telematics device. For instance, telematics device 313 may be configured to receive and transmit data from certain vehicle sensors 311 or systems, while other sensors or systems may be configured to directly receive and/or transmit data to a real-time hazard-based insurance system server 350 without using the telematics device 313. Thus, telematics device 313 may be optional in certain embodiments.

The hazard-based driving analysis system 300 in FIG. 3 also includes a mobile device 330. Mobile devices 330 may be, for example, smartphones or other mobile phones, personal digital assistants (PDAs), tablet computers, and the like, and may include some or all of the elements described above with respect to the computing device 101. As shown in this example, some mobile devices in hazard-based driving analysis system 300 (e.g., mobile device 330) may be configured to establish communication sessions with vehicle-based devices and various internal components of vehicle 310 via wireless networks or wired connections (e.g., for docked devices), whereby such mobile devices 330 may have secure access to internal vehicle sensors 311 and other vehicle-based systems. However, in other examples, the mobile device 330 might not connect to vehicle-based computing devices and internal components, but may operate independently by communicating with vehicle 310 via their standard communication interfaces (e.g., telematics device 313, etc.), or might not connect at all to vehicle 310.

Mobile device 330 may include a network interface 321, which may include various network interface hardware (e.g., adapters, modems, wireless transceivers, etc.) and software components to enable mobile device 330 to communicate with real-time hazard-based insurance system server 350, vehicle 310, and various other external computing devices. One or more specialized software applications, such as a driving analysis application 334 and/or a hazard unit based insurance application 335 may be stored in the memory of the mobile device 330. The driving analysis application 334 and hazard unit based insurance application 335 may be received via network interface 321 from the real-time hazard-based insurance system server 350, vehicle 310, or other application providers (e.g., application stores). As discussed below, the driving analysis application 334 and hazard unit based insurance application 335 may include one or more user interface screens. The memory of the mobile device 330 also may include databases configured to receive and store vehicle data, driving data, driving trip data, and the like, associated with one or more drivers and/or vehicles.

Like the vehicle-based computing devices in vehicle 310, mobile device 330 also may include various components configured to generate and/or receive vehicle data, driver data, and driving data or other operational data. For example, using data from the GPS receiver 333, a driving analysis software application 334 may be able to identify starting and stopping points of driving trips, determine driving speeds, times, routes, and the like. Additional components of mobile device 330 may be used to generate or receive driving data for the driving data analysis application 334 and/or hazard unit based insurance application 335, such as an accelerometer, compass, and various cameras and proximity sensors. In some arrangements, the mobile device 330 may include one or more sensors similar to sensors 311 arranged in the vehicle 310. As discussed below, these and other mobile device components may be used to receive, store, and output various user/driver data, to identify starting and stopping points and other characteristics of driving trips, to determine various driving data such as speeds, driving routes and times, acceleration, braking, and turning data, and other driving conditions and behaviors. In some implementations, the driving analysis software application 334 may store and analyze the data from various mobile device components, and the hazard unit based insurance application 335 may use this data, alone or in any combination with other components or devices (e.g., real-time hazard-based insurance system server 350), to determine and present insurance offers, insurance costs, and the like.

When mobile computing devices within vehicles are used to detect vehicle driving data and/or to receive vehicle driving data from vehicle sensors, such mobile computing devices 330 may store, analyze, and/or transmit the vehicle driver data (e.g., data identifying a current driver), driving data (e.g., speed data, acceleration, braking, and turning data, and any other vehicle sensor or operational data), and driving trip data (e.g., driving route, driving times, driving destinations, etc.), to one or more other devices. For example, mobile computing device 330 may transmit driver data, driving data and driving behaviors, and driving trip data directly to one or more real-time hazard-based insurance servers 350, and thus may be used in conjunction with or instead of telematics devices 313. Moreover, the processing components of the mobile computing device 330 may be used to identify vehicle drivers and passengers, analyze vehicle driving data, analyze driving trips, determine parameters related to aspects of hazard unit based insurance policies, and perform other related functions. Therefore, in certain embodiments, mobile computing device 330 may be used in conjunction with, or in place of, the real-time hazard-based insurance system server 350.

Vehicle 310 may include driving analysis computer 314, which may be separate computing devices or may be integrated into one or more other components within the vehicle 310, such as the telematics device 313, autonomous driving systems, or the internal computing systems of vehicle 310. As discussed above, driving analysis computer 314 also may be implemented by computing devices independent from the vehicle 310, such as mobile computing device 330 of the drivers or passengers, or one or more separate computer systems (e.g., a user's home or office computer). In any of these examples, the driving analysis computer 314 may contain some or all of the hardware/software components as the computing device 101 depicted in FIG. 1. Further, in certain implementations, the functionality of the driving analysis computer 314, such as receiving a preliminary navigational route, parsing the preliminary navigational route into a plurality of road segments, receiving, from at least one sensor arranged on a vehicle, driving data associated with a driver of the vehicle or the preliminary navigational route, calculating, for each road segment of the plurality of road segments and based in part on the driving data, a road segment hazard score, calculating a total route hazard score based on the road segment hazard score calculated for each road segment of the plurality of road segments, transmitting the total route hazard score to a first computing device and a second computing device, receiving, from the first computing device, a first bid to insure the vehicle as it travels along the preliminary navigational route for a first premium amount, receiving, from the second computing device, a second bid to insure the vehicle as it travels along the preliminary navigational route for a second premium amount, and selecting one of the first bid and the second bid, may be performed in a central real-time hazard-based insurance system server 350 rather than by the individual vehicle 310 or personal mobile device 330. In such implementations, the vehicle 310 and and/or mobile device 330, might only collect and transmit driver data, vehicle data, driving data, and the like to a real-time hazard-based insurance system server 350, and thus the vehicle-based driving analysis computer 314 may be optional.

The hazard-based driving analysis system 300 also may include one or more real-time hazard-based insurance servers 350, containing some or all of the hardware/software components as the computing device 101 depicted in FIG. 1. The real-time hazard-based insurance system server 350 may include hardware, software, and network components to receive driver data, vehicle data, and vehicle operational data/driving data from one or more vehicles 310, mobile devices 330, and other data sources. The real-time hazard-based insurance system server 350 may include an insurance database 352 and real-time hazard-based insurance system 351 to respectively analyze data received from vehicle 310, mobile device 330, and other data sources. In some examples, the real-time hazard-based insurance system 351 may include many or all of the components of real-time hazard-based insurance system 200 described with respect to FIG. 2.

The real-time hazard-based insurance system server 350 may initiate communication with and/or retrieve driver data, vehicle data, and driving data from vehicle 310 wirelessly via telematics device 313, mobile device 330, or by way of separate computing systems over one or more computer networks (e.g., the Internet). Additionally, the real-time hazard-based insurance system server 350 may receive additional data from other third-party data sources, such as external traffic databases containing traffic data (e.g., amounts of traffic, average driving speed, traffic speed distribution, and numbers and types of accidents, etc.) at various times and locations, external weather databases containing weather data (e.g., rain, snow, sleet, and hail amounts, temperatures, wind, road conditions, visibility, etc.) at various times and locations, and other external data sources containing driving hazard data (e.g., road hazards, traffic accidents, downed trees, power outages, road construction zones, school zones, and natural disasters, etc.), route and navigation information, and insurance company databases containing insurance data (e.g., driver score, coverage amount, deductible amount, premium amount, insured status) for the vehicle, driver, and/or other nearby vehicles and drivers.

Data stored in the insurance database 352 may be organized in any of several different manners. For example, a driver table in insurance database 352 may contain all of the driver data for drivers associated with the insurance provider (e.g., driver personal information, insurance account information, demographic information, accident histories, hazard factors, driving scores and driving logs, etc.), a vehicle table may contain all of the vehicle data for vehicles associated with the insurance provider (e.g., vehicle identifiers, makes, models, years, accident histories, maintenance histories, travel logs, estimated repair costs and overall values, etc.), and a driving trip table may store all of the driving trip data for drivers and vehicles associated with the insurance provider (e.g., road segment identification, road segment hazard scores, driving trip driver, vehicle driven, trip time, starting and ending points, route driven, etc.). Other tables in the database 352 may store additional data, including data types discussed above (e.g. traffic information, road-type and road condition information, weather data, insurance policy data, etc.). Additionally, one or more other databases of other insurance providers containing additional driver data and vehicle data may be accessed to retrieve such additional data.

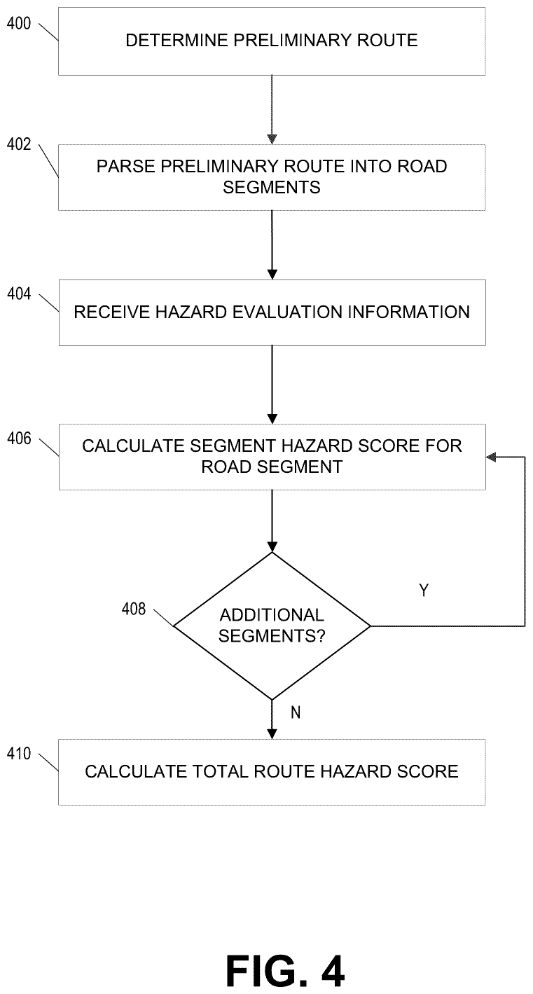

The real-time hazard-based insurance system 351 within the real-time hazard-based insurance system server 350 may be configured to retrieve data from the insurance database 352, or may receive driver data, vehicle data, and driving trip directly from vehicle 310, mobile device 330, or other data sources, and may perform driving data analyses, determine or generate road segment hazard scores, and other related functions. The functions performed by the real-time hazard-based insurance system 351 may be performed by specialized hardware and/or software separate from the additional functionality of the real-time hazard-based insurance system server 350. Such functions may be similar to those of driving analysis module 314 of vehicle 310, and the driving analysis and road segment safety rating applications 334 and 335 of mobile device 330, and further descriptions and examples of the algorithms, functions, and analyses that may be executed by the real-time hazard-based insurance system 351 are described below, including in reference to FIGS. 4-8.

In various examples, the driving data and driving trip analyses and/or road segment hazard score determinations may be performed entirely in the real-time hazard-based insurance system server 350, may be performed entirely in the vehicle-based driving analysis computing module 314, or may be performed entirely in the driving analysis and road segment safety rating applications 334 and 335 of mobile device 330. In other examples, certain analyses of driver data, vehicle data, and driving trip data, and certain road segment hazard score determinations may be performed by vehicle-based devices (e.g., within driving analysis module 314) or mobile device 330 (e.g., within applications 334 and 335), while other data analyses and road segment hazard score determinations are performed by the real-time hazard-based insurance system 351 at the real-time hazard-based insurance system server 350. For example, a vehicle-based driving analysis computer 314, or the hardware and software components of mobile device 330 may continuously receive and analyze driver data, vehicle data, driving trip data, and the like to determine certain events and characteristics (e.g., commencement of a driving trip, identification of a driver, determination of a driving route, parsing of the driving route into one or more road segments, determination of driving data and behaviors during driving trips, etc.), so that large amounts of data need not be transmitted to the real-time hazard-based insurance system server 350. However, for example, after driver, vehicle, and/or driving trip is determined by a vehicle-based device and/or mobile device, corresponding information may be transmitted to the real-time hazard-based insurance system server 350 to perform road segment hazard analysis, determining service providers for insuring one or more of the road segments, performing route modification, etc. which may be transmitted back to the vehicle-based device and/or personal mobile devices.

FIG. 4 is a flow chart illustrating one example method of calculating a hazard score for a navigational route, according to one or more aspects described herein. The example method may be performed by any one or more of the computing devices described above, such as, but not limited to, real-time hazard-based insurance computing device 101, real-time hazard-based insurance system 200, personal mobile device 330, and/or real-time hazard-based insurance system server 350.

At step 400, a preliminary navigational route may be received. In one arrangement, a user may enter a starting location and a destination location into a computing device, such as a navigation device or personal mobile device 330. The computing device may then generate a preliminary navigational route from the starting location to the destination location (i.e. the computing device executing the method illustrated in FIG. 4). In some arrangements, the user may further enter additional data, such as a preference for a shortest route, fastest route, and the like. In some arrangements, the user may further enter an acceptable hazard level for the preliminary route. The user may enter the acceptable hazard level for the preliminary route via a graphical slider presented to the user on a user interface. A preliminary navigational route may then be determined based on the user's inputs. The preliminary navigational route may be received by the computing device that is calculating the hazard score for the preliminary navigational route. At step 402, the preliminary navigational route may be parsed into one or more road segments. In some examples, a road segment may be some or all of a particular road. As discussed above, the road segments may have varying lengths or distances, may be formed of various materials, may include various types of roads (e.g., highway, country road, etc.), and the like.

At step 404, hazard evaluation information for a road or road segment may be received. Hazard evaluation information may be any information that may be utilized to calculate a hazard score for a road segment. As indicated above, at least some of the data used to determine a road segment hazard score may be received from one or more data stores, such as data stores 204 and 206. Data that may be used to determine a road segment hazard score may include historical accident information associated with a particular road segment, traffic volume information associated with a particular road segment, severity of accident associated with a particular road segment (e.g., based on previously received insurance claim data), and the like. In some examples, geocoded data may be received from data store 206 and may be used to determine a hazard score for one or more road segments. In some arrangements, additional information such as type of road segment (2-lane highway, 4-lane highway, rural road, etc.), condition of road segment (e.g., newly resurfaced, severely damaged, etc.), and the like (as discussed above), may be used to determine the road segment hazard score. Hazard evaluation data received from internal data store 204 may include information associated with accidents associated with the road segment, accidents associated with that type of road or one or more features of the road segment (e.g., number of bends, merging, etc.), severity of accidents associated with the road segment (e.g., based on insurance claim data), number of accidents associated with the road segment, time of day of accident, date of accident, and the like. The internal data store 204 may also include information associated with conditions of the road segment (e.g., pot holes, type of road, etc.). In some arrangements, this information may be received from a telematics device associated with one or more vehicles, and associated sensors detecting such information.

Data received from external data store 206 may include additional information associated with the type of road, condition of the road, etc. Hazard evaluation data received from external data store 206 may include information gathered from various sources regarding accidents associated with the road segment, traffic volume associated with the road segment, and the like. In some examples, data received from external data store 206 may include information associated with environmental or weather conditions surrounding a road segment. Accordingly, the road segment hazard score may be based on real-time or near real-time data, such as current weather conditions (e.g., rain, snow, fog, etc.) and current traffic conditions. Some example algorithms that may be used to determine a road segment hazard score are provided below. The example algorithms provided are merely examples and various other algorithms may be used to determine road segment hazard score without departing from the invention.

Hazard evaluation data may further include data associated with a driver of the vehicle. For instance, driver-specific data may be received from the plurality of sensors 216a-216c discussed above. The sensors 216a-216c may be used to obtain data associated with driving behaviors of the user, such as hard braking, speeding, and the like. In another example, hazard evaluation data received from one or more sensors may include environmental conditions such as precipitation, humidity, cloud cover, or the like. In still another example, hazard evaluation data received from one or more sensors may include road conditions or information from outside sources (e.g., external databases, or the like) regarding traffic conditions, types of road (e.g., two-lane road, four-lane road), speed limit of the road, or the like. Additionally, or alternatively, hazard evaluation information may be received from driving behavior module 214. As discussed above, driving behavior module may analyze sensor data received from one or more of sensors 216a-216c and may identify one or more driving behaviors of a particular driver or operator of the vehicle. For instance, the driving behavior module 214 may determine whether the user generally drives at a speed over the speed limit, generally follows too closely behind a vehicle in front of him, generally brakes hard, and the like. This information may be received at step 404 for use in determining a hazard score for a particular road segment.

At step 406, a hazard score may be determined for a road segment of the road segments determined at step 402. In some examples, the road segment hazard score may be based on static variables from the hazard evaluation data (e.g., variables that do not change rapidly or frequently). These variables may be received from data stores 204, 206, sensors 216a-216c, or another third-party data source. For instance, one example algorithm may be:

Road segment hazard score=exp (prior accident frequency on the road segment*W₁+road curvature*W₂+road segment has lane merge*W₃+road segment has merge from left*W₄).

W₁ though W₄ may be weighting factors applied to each variable.

In other examples, the road segment hazard score may be based on a combination of static factors (similar to the equation above) as well as one or more dynamic road factors from the hazard evaluation information (e.g., factors associated with the road segment that may change rapidly or frequently). For instance,

Road segment hazard score=exp (prior accident frequency on the road segment*W₁+road curvature*W₂+road segment has lane merge*W₃+road segment has merge from left*W₄+road segment has construction*W₅+number of inches of snow on road segment*W₆+road segment is wet*W₇+traffic factor*W₈).

In this example algorithm, W₁ though W₈ represent weighting factors and variables such as road segment has construction, number of inches of snow on road segment, road segment is wet, and traffic factor may be dynamic factors used in combination with the static factors described above.

In still other examples, the road segment safety rating may be based on static factors from the hazard evaluation data, dynamic factors from the hazard evaluation data, as well as one or more driver behavior factors from the hazard evaluation data. For instance,

Road segment hazard score=exp (prior accident frequency on the road segment*W₁+road curvature*W₂+road segment has lane merge*W₃+road segment has merge from left*W₄+road segment has construction*W₅+number of inches of snow on road segment*W₆+road segment is wet*W₇+traffic factor*W₈+(road curvature*driver takes curves fast*W₉)+(number of inches of snow*driver brakes hard*W₁₀)).

In this example, W₁ through W₁₀ are weighting factors and variables such as “driver takes curve fast” and “driver brakes hard” are example driving behaviors that may be used to determine a road segment safety rating particular to a driver.

The algorithms and variables shown above are for illustrative purposes, and various other algorithms, various different weighting factors, additional or different variables, etc. may be used without departing from the invention. The above-described algorithms are merely some examples of algorithms that may be used to determine a road segment hazard score and should not be viewed as limiting the invention to only those example algorithms provided.

At step 408, it may be determined whether there are additional road segments within the preliminary navigational route. If there are additional road segments, processing may return to step 406, where a road segment hazard score may be calculated for the next road segment. If there are no additional road segments (that is, a hazard score has been calculated for each road segment determined at step 402), processing may proceed to step 410, where a total route hazard score may be calculated. In one arrangement, the total route hazard score may be determined by summing or averaging the hazard score calculated for each road segment. In another arrangement, the total route hazard score may be determined by first summing or averaging the hazard score calculated for each road segment, and then adjusting that value based on one or more factors. For example, if the number of road segments having individual hazard scores above a threshold exceeds a first value, the summed or averaged value may be increased.

FIG. 5 illustrates one example of a real-time vehicular service exchange within a real-time hazard-based insurance system. Control module 501 may correspond or be similar to control module 202 in FIG. 2. Control module 501 of real-time hazard-based insurance system may communicate with real-time vehicular service exchange 500 via Internet 505. Real-time vehicular service exchange 500 may include one or more computing devices 510, 520, and 530. Each of the computing devices 510, 520, and 530 may be associated with entities 515, 525, and 535, respectively. Entities 515, 525, and 535 may each be a different insurance provider.

Computing devices 510, 520, and 530 may each be configured to receive one or more total route hazard scores associated with one or more preliminary navigational routes from control module 501 via Internet 505. Computing devices 510, 520, and 530 (or entities 515, 525, and 535) may each further be configured to analyze a total route hazard score. Computing devices 510, 520, and 530 may further be configured to decide whether to place a bid to insure the vehicle as it travels along the preliminary navigational route based in part on the total route hazard score assigned to the preliminary navigational route. If a computing device decides to place a bid on insuring the vehicle as it travels along the preliminary navigational route, the computing device may further be configured to transmit the bid to control module 501. The bids transmitted by the computing devices may include, along with the premium amounts, data related to the type or amount of coverage offered by the service provider and a deductible for which the driver would be responsible.

In a first example, control module 501 may transmit a first preliminary navigational route and corresponding first total route hazard score to each of computing devices 510, 520, and 530 via Internet 505. Computing device 510 may analyze the first preliminary navigational route and corresponding first total route hazard score. Based on its analysis, computing device 510 may determine not to bid on insuring the vehicle as it travels along the first preliminary navigational route. Computing device 520 may analyze the first preliminary navigational route and corresponding first total route hazard score and decide to place a bid for a first premium amount. Similarly, computing device 530 may analyze the first preliminary navigational route and corresponding first total route hazard score and decide to place a bid for a second premium amount. The first premium amount and the second premium amount may be the same amount or different amounts. Computing device 520 may transmit the first premium amount to control module 501 via Internet 505. Similarly, computing device 530 may transmit the second premium amount to control module 501 via Internet 505. Control module 501 may receive each of the bids (i.e. premium amount) placed by the computing devices 520 and 530. Control module 501 may select a bid from the received bids or may transmit the bids to the driver so that the driver may select a bid from the received bids. Each of computing devices 520 and 530 may receive information indicating whether its respective bid was selected.

In addition to providing bids to control module 501, computing devices 510, 520, and 530 may provide alternative bids to the control module 501. For example, control module 501 may transmit a preliminary navigational route associated with a driver and a total route hazard score to each of computing devices 510, 520, and 530 via Internet 505. Entity 515 may decide, based in part on the total route hazard score, to offer to insure the vehicle as it travels along the preliminary navigational route for a first premium amount. Entity 515 may further decide to insure a potential alternative route that has a total route hazard score equal to or below a second value for a second premium amount. Computing device 510 may transmit information to control module 501 indicating that entity 515 will insure the vehicle as it travels along the preliminary navigational route for a first premium amount. Computing device 510 may further transmit information to control module 501 indicating that the first insurance company will insure the vehicle as it travels along a potential alternative route that has a total route hazard score equal to or below a second value for a second premium amount. The control module 501 may then determine if there is an alternative route that has a total route hazard score equal to or below a second value. Continuing with this example, entity 525 may analyze the preliminary navigational route and corresponding total route hazard score and decide not to place a bid for insuring the vehicle as it travels along the preliminary navigational route. Entity 525 may further decide to insure a potential alternative route that has a total route hazard score equal to or below a third value for a third premium amount. Computing device 520 may transmit information to control module 501 indicating that entity 525 will not place a bid to insure the vehicle as it travels along the preliminary navigational route but that it will insure a potential alternative route that has a total route hazard score equal to or below a third value for a third premium amount. The control module 501 may then determine if there is an alternative route that has a total route hazard score equal to or below a third value. Entity 535 may analyze the preliminary navigational route and corresponding total route hazard score and decide not to place a bid for insuring the vehicle as it travels along the preliminary navigational route. Entity 535 may further decide not to place any alternative bids. Each of the bids for insuring the vehicle as it travels along the preliminary navigational route and each of the bids for insuring the vehicle as it travels along each alternate route may be presented to a user. The user may then select a route and corresponding bid. Alternatively, control module 501 may select a route and corresponding bid. Control module 501 may transmit information to each of computing device 510, 520, and 530 indicating whether or not its bid was selected.

Additionally, or alternatively, control module 501 may transmit the hazard score for each road segment to real-time vehicular service exchange 500. Computing devices 510, 520, and 530 may each be configured to receive information identifying one or more road segments and a corresponding hazard score for each of the one or more road segments. Computing devices 510, 520, and 530 (or entities 515, 525, and 535) may each further be configured to analyze the information identifying one or more road segments and the corresponding hazard score for each of the one or more road segments. Computing devices 510, 520, and 530 (or entities 515, 525, and 535) may further be configured to decide whether to place a bid to insure the vehicle as it travels along one or more of the road segments. If a computing device decides to place a bid on insuring the vehicle as it travels along the one or more road segments, the bid may be transmitted from the computing device to control module 501 via Internet 505.

For example, control module 501 may transmit a first road segment, a hazard score for the first road segment, a second road segment, and a hazard score for the second road segment to each of computing devices 510, 520, and 530. Entity 515 may decide to place a first bid to insure the vehicle as it travels along only the first road segment for a first premium amount. Entity 525 may decide to place a second bid to insure the vehicle as it travels along the first road segment for a second premium amount and to place a third bid to insure the vehicle as it travels along the second road segment for a third premium amount. The first premium amount, second premium amount, and the third premium amount may be the same or different. Entity 535 may decide not to bid on either road segment. Computing device 510 may transmit information to control module 501 indicating that the entity 515 bids to insure the vehicle as it travels along the first road segment for the first premium amount. Computing device 520 may transmit information to control module 501 indicating that entity 525 places a second bid to insure the vehicle as it travels along the first road segment for the second premium amount and a third bid to insure the vehicle as it travels along the second road segment for the third premium amount. Control module 501 may receive each of the bids. Control module 501 may select the optimal bids from the received bids (i.e. from the first bid, second bid, and the third bid) or may transmit the received bids to the user. For example, each of the bids may be presented to the user via a computing device, such as one or more of computing devices 212a-212f. The user may then select one or more bids from the received bids. The user's selections may be transmitted to control module 501. The control module 501 may then send information to computing device 510 and 520 indicating whether the bids received from the respective devices were selected.

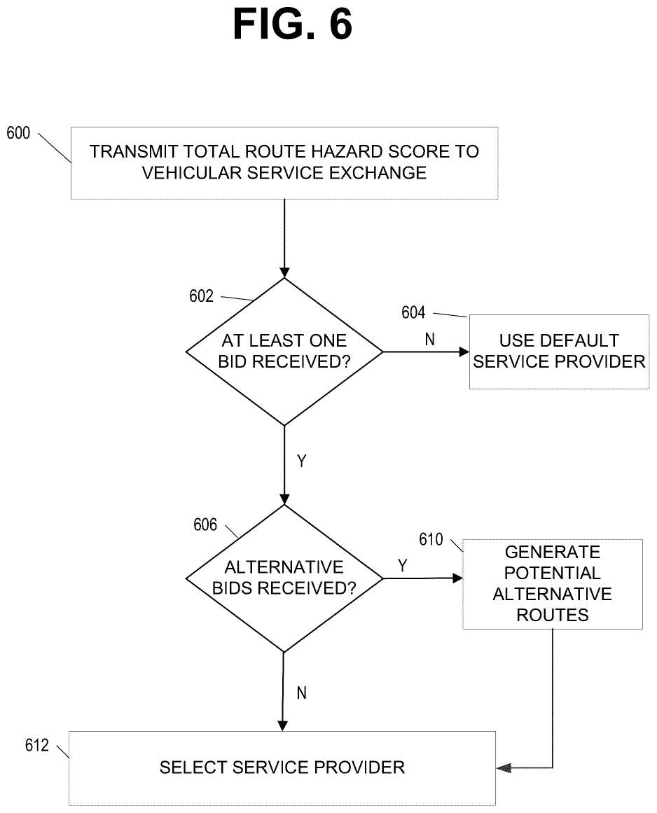

FIG. 6 illustrates one example method for insuring a vehicle travelling along a preliminary navigational route based on a total route hazard score via a real-time hazard-based insurance system according to one or more aspects described herein. The steps in the example method may be executed by one or more computing devices, such as real-time hazard-based insurance computing device 101, real-time hazard-based insurance system 200, vehicle 310, personal mobile device 330, and/or real-time hazard-based insurance system server 350. At step 600, the total route hazard score for a preliminary navigational route may be transmitted to a real-time vehicular service exchange, such as real-time vehicular service exchange 500. The total route hazard score may be received by each computing device in the real-time vehicular service exchange. Each computing device may then analyze the preliminary navigational route and corresponding total route hazard score to determine whether to place a bid to insure the vehicle as it travels along the preliminary navigational route. Additionally, or alternatively, each computing device may determine to bid on insuring a potential alternative route that has a total route hazard score equal to or below a select value. Each computing device may then transmit bids or alternative bids to a control module, such as control module 501. Each of the bids transmitted by the computing devices may include a premium amount, data related to the type or amount of coverage offered by the service provider and a deductible that the driver would be responsible for. At step 602, it may be determined whether at least one bid or alternative bid was received from a computing device in the real-time vehicular service exchange. If no bids are received from the real-time vehicular service exchange (i.e. none of the entities in the real-time vehicular service exchange have placed a bid to insure the vehicle as it travels along the preliminary navigational route), at step 604, a default service provider may be used to insure the vehicle as it travels along the preliminary navigational route. The default service provider may be the entity maintaining the real-time hazard-based insurance system. In another arrangement, a default service provider may be selected by the entity maintaining the real-time hazard-based insurance system. Alternatively, a default service provider may have been pre-selected by a user of the real-time hazard-based insurance system. Alternatively, if no bids are received from the real-time vehicular service exchange, route modification may be performed. Route modification may include generating a new preliminary navigational route that has a lower total route hazard score than the total route hazard score of the preliminary navigational route received at step 402. The modified route may be presented to the user prior to the real-time hazard-based insurance system sending the total route hazard score for the new preliminary navigational route to the real-time vehicular service exchange.

If at least one bid or alternative bid is received from a computing device within real-time vehicular service exchange at step 602, it may be determined, at step 606, whether any of the received bids are alternative bids. As discussed above in reference to FIG. 5, an entity within real-time vehicular service exchange may offer to insure the vehicle as it travels along a potential alternative route that has a total route hazard score equal to or below a select value. The potential alternative route may not be known to the entity at the time the alternative bid is placed. Put differently, the alternative bid may be viewed as a counter-offer by the entity-if the preliminary navigational route can be adjusted (i.e. an alternative route can be found) that has a total route hazard score equal to or below the select value, the entity will insure that alternative route for the amount included in the bid. Accordingly, if alternative bids were received, at step 610, it may be determined whether an alternative route that has a total route hazard score equal to or below a specified value can be generated. If multiple alternative bids are received, the process of determining whether an alternative route that has a total route hazard score equal to or below a specified value can be generated may be repeated for each alternative bid.

For example, the example method may be executed by real-time hazard-based insurance system 200. Real-time hazard-based insurance system 200 may transmit a preliminary navigational route (from a start location to a destination location) and corresponding total route hazard score to a real-time vehicular service exchange, such as real-time vehicular service exchange 500. Real-time hazard-based insurance system 200 may receive a first bid from computing device 510. The first bid may indicate that entity 515 has placed a first bid to insure the vehicle as it travels along the preliminary navigational route for a first premium amount. Real-time hazard-based insurance system 200 may further receive a second bid from computing device 510. The second bid may indicate that entity 515 has placed a second bid to insure the vehicle as it travels along a first potential alternative route for a second premium amount if the total route hazard score associated with the first potential alternative route is equal to or below a first value. Real-time hazard-based insurance system 200 may further receive a third bid from computing device 520. The third bid may indicate that entity 525 has placed a third bid to insure the vehicle as it travels along the preliminary navigational route for a third premium amount. Real-time hazard-based insurance system 200 may further receive a fourth bid from computing device 530. The fourth bid may indicate that entity 535 has placed a fourth bid to insure the vehicle as it travels along a second potential alternative route for a fourth premium amount if the total route hazard score associated with the second potential alternative route is equal to or below a second value. At step 610, real-time hazard-based insurance system 200 may determine if there exists a route from the start location to the destination location that has a total route hazard score equal to or less than the first value. In this example, real-time hazard-based insurance system 200 may determine that such a first alternative route may be generated. Real-time hazard-based insurance system 200 may further determine if a route from the start location to the destination location that has a total route hazard score equal to or less than the second value may be generated. In this example, real-time hazard-based insurance system 200 may determine that such a route does not exist. Accordingly, in this example, the options for insurance are as follows: the first entity may insure the vehicle as it travels along the preliminary navigational route for the first premium value (corresponding to the first bid discussed above), the first entity may insure the vehicle as it travels along the first alternative route for the second premium value (corresponding to the second bid discussed above), and the second entity may insure the vehicle as it travels along the preliminary navigational route for the third premium value (corresponding to the third bid discussed above). As no route between the start point and the destination point with a total route hazard score equal to or below the second value could be generated at step 610, the fourth bid is eliminated by the real-time hazard-based insurance system 200.

At step 612, a service provider (i.e. one of the entities from the real-time vehicular service exchange) may be selected based on an analysis of all received bids. In one arrangement, the entity that offered to insure the vehicle as it travels along the preliminary navigational route for the lowest premium amount may be automatically selected. In another arrangement, if a bid was received from a preferred entity, that bid may be automatically selected. The preferred entity may be preselected by the user of the real-time hazard-based insurance system or by the entity maintaining real-time hazard-based insurance system. If only alternative bids are received, then an alternative bid associated with an alternative route that has a minimal deviation from the preliminary navigational route may be automatically selected. In another arrangement, each of the received bids may be transmitted to the driver or user of the real-time hazard-based insurance system. The bids may be transmitted to a computing device associated with the user or driver, such as computing devices 212a-212f shown in FIG. 2. The bids may be displayed on a display screen of the computing device. The user may then select the desired bid. The selected bid may then be transmitted from the computing device associated with the user to the computing device executing the method shown in FIG. 6. The computing device may transmit information identifying the selected bid to each of the computing devices in the real-time vehicular service exchange. The computing device may further transmit information identifying the selected bid to the entity maintaining the real-time hazard-based insurance system.

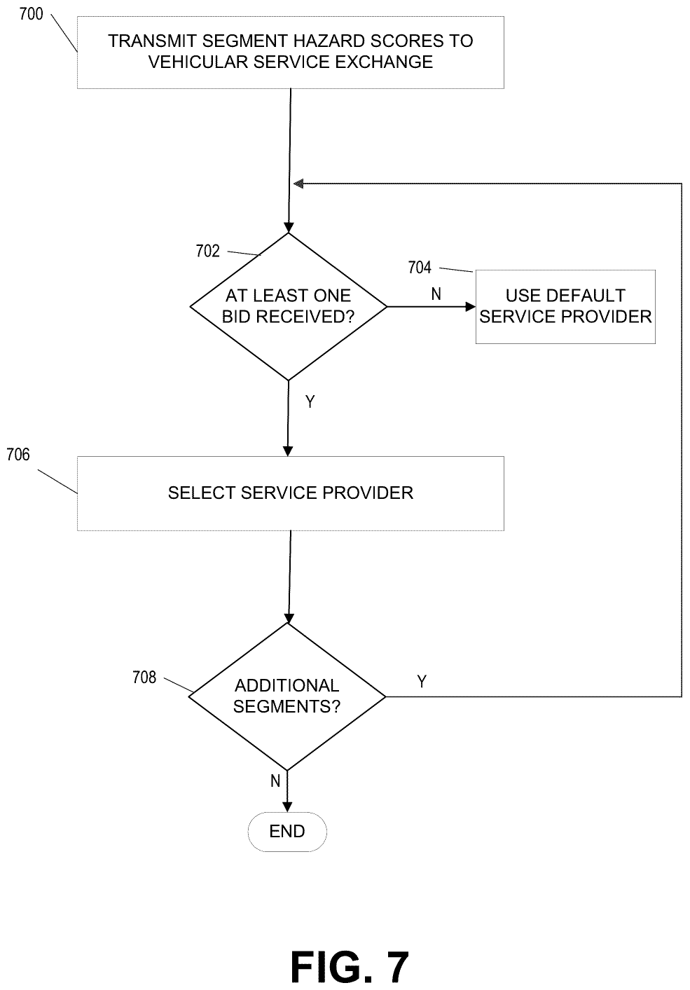

FIG. 7 illustrates one example method for insuring a vehicle as it travels along a preliminary navigational route based on individual hazard scores for road segments via a real-time hazard-based insurance system according to one or more aspects described herein. The steps in the example method may be executed by one or more computing devices, such as real-time hazard-based insurance computing device 101, real-time hazard-based insurance system 200, vehicle 310, personal mobile device 330, and/or real-time hazard-based insurance system server 350. At step 700, the hazard score calculated for each road segment of a preliminary navigational route (i.e. each of the hazard scores calculated at step 406 in FIG. 4, as discussed above) along with information identifying the corresponding road segment may be transmitted to the real-time vehicular service exchange, such as real-time vehicular service exchange 500. The hazard score calculated for each road segment and the information identifying the corresponding road segment may be received by each computing device in the real-time vehicular service exchange. Each computing device may then analyze the hazard score calculated for each road segment and the information identifying the corresponding road segment to determine whether to place a bid to insure one or more of the road segments.

For example, a first preliminary navigational route may include a first road segment that has a first road segment hazard score, a second road segment that has a second road segment hazard score, and a third road segment that has a third road segment hazard score. Each of these road segments and road segment hazard scores may be sent to computing devices 510, 520, and 530. Computing devices 510, 520, and 530 (or the entities associated with the computing devices) may analyze the road segment hazard scores and decide whether or not to bid on insuring the road segments. The entities may bid on none of the road segments, some of the road segments, or all of the road segments. The bids from each of the computing devices or corresponding entities may be transmitted from the computing device to control module 501 via Internet 505. The bids transmitted by the computing devices may include, along with the premium amounts, data related to the type or amount of coverage offered by the service provider and a deductible that the driver would be responsible for. In this example, computing device 510 may transmit one or more bids indicating that entity 515 will insure the first road segment for a first premium amount and the second road segment for a second premium amount. Computing device 520 may transmit one or more bids indicating that entity 525 will insure the second road segment for a third premium amount. Entity 535 may determine that it will not place a bid on any of the road segments. Accordingly, computing device 530 may transmit no bids to control module 501. Computing device 530 may optionally transmit a notification to control module 501 indicating that entity 535 will not bid on any of the first road segment, second road segment, and third road segment.

At step 702, it may be determined, for a road segment of each of the road segments, whether at least one bid to insure a vehicle as it travels along that road segment was received from the real-time vehicular service exchange. If, at step 702, it is determined that no bid was received for that road segment, processing may proceed to step 704, where a default service provider may be selected to insure the vehicle as it travels along that road segment. If, at step 702, it is determined that one or more bids are received, then processing may proceed to step 706, where a service provider for insuring the vehicle as it travels along that road segment may be selected based on the received bids. If only one bid is received at step 702 for a road segment, the entity associated with the one bid may be selected as the service provider for insuring that road segment. If multiple bids are received at step 702, one bid from the multiple bids may be selected. In one arrangement, the entity that offered to insure the vehicle as it travels along the road segment for the lowest premium amount may be automatically selected as the service provider for insuring that road segment. In another arrangement, if a bid to insure the vehicle as it travels along a road segment was received from a preferred entity, that preferred entity may be automatically selected as the service provider for insuring the vehicle as it travels along that road segment. The preferred entity may be preselected by the user of the real-time hazard-based insurance system or by the entity maintaining real-time hazard-based insurance system. In yet another arrangement, each of the received bids for the road segment may be transmitted to the driver or user of the real-time hazard-based insurance system. The bids may be transmitted to a computing device associated with the user or driver, such as computing devices 212a-212f shown in FIG. 2. The bids for the road segment may be displayed on a display screen of the computing device. The user may then select the desired bid for insuring the vehicle as it travels along the road segment. The selected bid for the road segment may then be transmitted from the computing device associated with the user to the computing device executing the method shown in FIG. 7. The computing device may transmit information identifying the selected bid to each of the computing devices in the real-time vehicular service exchange. The computing device may further transmit information identifying the selected bid to the entity maintaining the real-time hazard-based insurance system. At step 708, it may be determined if there are additional road segments. If there are additional road segments, processing may return to step 702, where it may be determined if at least one bid was received for the next road segment. Steps 702, 704, 706, and 708 may be repeated for each road segment in the preliminary navigational route.

Continuing with the example above, at step 702, it may be determined that one bid (i.e. from entity 515) was received for the first road segment in the first preliminary navigational route. Accordingly, entity 515 may be selected as the service provider for insuring the vehicle as it travels along the first road segment at step 706. At step 708, it may be determined that there are additional road segments (i.e. the second road segment and the third road segment) in the first preliminary navigational route and processing may return to step 702. At step 702, it may be determined that two bids (i.e. one from entity 515 and one from entity 525) were received for insuring the vehicle as it travels along the second road segment. At step 706, a service provider may be selected by the computing device executing the method or by a user of the real-time hazard-based insurance system. At step 708, it may be determined that there are additional road segments (i.e. the third road segment) and processing may return to step 702. At step 702, it may be determined that no bids were received for insuring the vehicle as it travels along the third road step. Accordingly, at step 704, a default service provider may be selected for the third road segment. The default service provider may be pre-configured by the real-time hazard-based insurance system or by the entity maintaining the real-time hazard-based insurance system. At step 708, it may be determined that there are no additional road segments in the preliminary navigational route and processing may end.

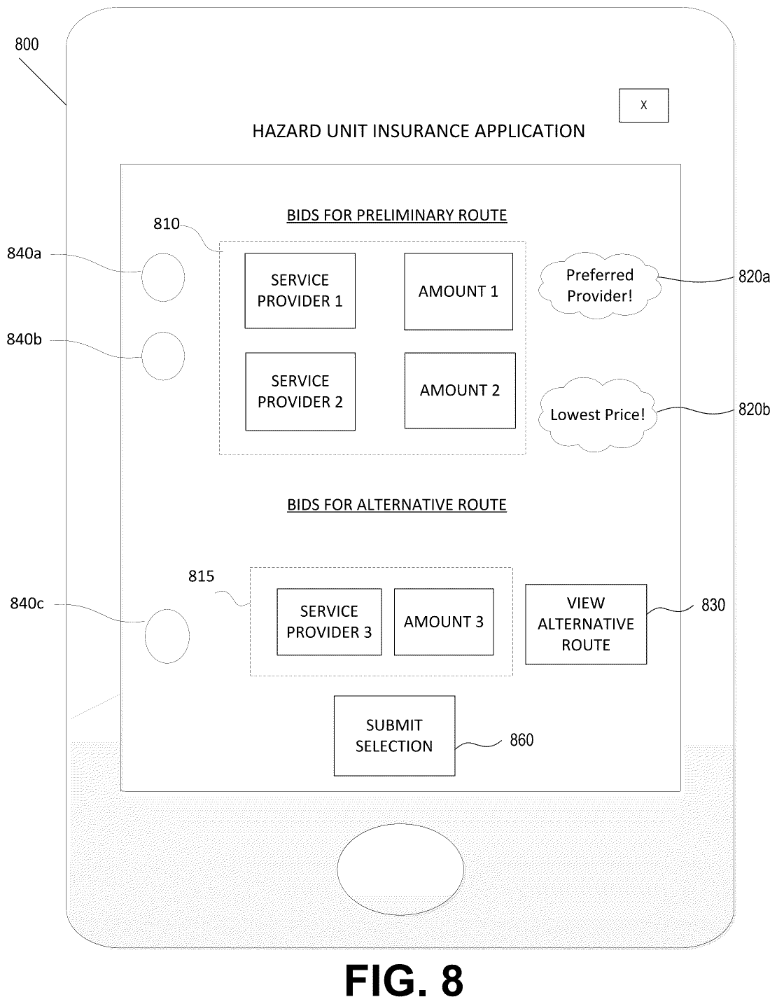

FIG. 8 illustrates an example user interface 800 that may be used to receive a user selection for a service provider for a route for a hazard-based insurance system. Although interface 800 is shown in FIG. 8 as being displayed on a mobile device, the interface provided may be displayed on various different types of computing devices, including, for instance, a vehicle display, laptop or desktop computing device, tablet computing device, and the like. Interface 800 may include display area 810, which may display each bid for insuring a preliminary navigational route that was received from a real-time insurance exchange. Display area 810 may indicate the service provider associated with the bid (i.e. one of entity 515, 525, and 535) and the premium amount that the service provider offered to insure the preliminary navigational route for. Notifications 820a and 820b may include data highlighting advantages of selecting each of the bids. For example, a user may have previously indicated a preferred service provider. If a bid for insuring the preliminary navigational route is received from the preferred service provider, notification 820 may highlight said bid by notifying the user that the bid is from the preferred service provider. Alternatively, the application may display a notification highlighting the lowest bid that was received for insuring the vehicle as it travels along the preliminary navigational route (shown as notification 820b). Similar notifications may be used by the application to highlight various advantages of one or more of the bids. Alternatively, or additionally, notifications may be displayed to highlight disadvantageous aspects of one or more bids. For example, a notification may be displayed indicating that a bid is the highest priced bid received. In another example, if a user has expressed dissatisfaction with a service provider in the past and one or more of the displayed bids are associated with that service provider, a notification may be displayed informing the user that those bids have been received from lesser-preferred service providers. Interface 800 may further include display area 815, which may display information regarding alternative bids that are received. Display area 815 may serve to indicate to the user with feed-back informing the customer that if they chose a different route, the quotes they received would be different. As discussed above in reference to FIGS. 5 and 6, a service provider may offer to insure the vehicle as it travels along an alternate route for a select amount. Display area 815 may include information indicating the service provider and the premium amount associated with insuring the vehicle as it travels along the alternative route. Display area 815 may further include graphical element 830, which, if selected by the user, may display the alternative route. The alternative route may be displayed within the hazard unit insurance application, or by a different application. Interface 800 may further include graphical elements 840a-c that may be utilized by the user to select one of the displayed bids. Interface 800 may further include graphical element 860 which, when selected by the user, may transmit the user's selection to an insurance company associated with the user. Additional information not shown in user interface 800 may additionally be presented to the user. For example, as discussed above in reference to FIG. 5, the computing devices of the real-time vehicular service exchange may transmit, along with the premium amounts, data related to the type or amount of coverage offered by the service provider and a deductible that the driver would be responsible for. Such information may be displayed within user interface 800 to give the driver more information regarding each bids.

While the aspects described herein have been discussed with respect to specific examples including various modes of carrying out aspects of the disclosure, those skilled in the art will appreciate that there are numerous variations and permutations of the above described systems and techniques that fall within the spirit and scope of the invention.

What is claimed is:

1. A real-time hazard-based navigational system comprising:
a driving behavior system receiving driver-specific data obtained using one or more sensors and analyzing the driver-specific data to identify one or more driving behaviors of a driver of a vehicle;
a hazard score analysis system parsing a preliminary navigational route into one or more road segments, receiving geocoded data associated with the one or more road segments, generating a road segment hazard score for each of the one or more road segments by analyzing the geocoded data and the one or more driving behaviors, generating a total hazard score using the road segment hazard score for each of the one or more road segments, and generating one or more route modifications when the total hazard score exceeds a threshold; and
a control system receiving the preliminary navigational route and transmitting the one or more route modifications to one or more computing devices to cause the one or more computing devices to indicate the one or more route modifications.

2. The real-time hazard-based navigational system of claim 1, wherein the one or more route modifications are generated using real-time data.

3. The real-time hazard-based navigational system of claim 2, wherein the real-time data includes at least one of weather data, traffic data, road conditions, traffic volume, accident severity, or environmental conditions.

4. The real-time hazard-based navigational system of claim 1, wherein the driver-specific data includes at least one of speed relative to speed limits, driving distance from other vehicles, hard braking, or swerving.

5. The real-time hazard-based navigational system of claim 1, wherein the one or more driving behaviors used to generate the road segment hazard score are weighted.

6. The real-time hazard-based navigational system of claim 1, wherein the one or more route modifications includes generating a navigational route that has a lower total hazard score than the total hazard score of the preliminary navigational route.

7. The real-time hazard-based navigational system of claim 1, wherein the one or more computing devices indicate the one or more route modifications using a user interface.

8. The real-time hazard-based navigational system of claim 1, wherein the total hazard score is determined by summing or averaging the road segment hazard score for each route segment.

9. The real-time hazard-based navigational system of claim 1, wherein the control system is further configured to receive, from the one or more computing devices, a threshold total route hazard score for determining the one or more route modifications.

10. A non-transitory computer-readable media having instructions stored thereon that, when executed by one or more processors, cause the one or more processors to:
receive driver-specific data obtained using one or more sensors;
analyze the driver-specific data to identify one or more driving behaviors of a driver of a vehicle;
parse a preliminary navigational route into one or more road segments;
receive geocoded data associated with the one or more road segments;
generate a road segment hazard score for each of the one or more road segments by analyzing the geocoded data and the one or more driving behaviors;
generate a total hazard score using the road segment hazard score for each of the one or more road segments;
generate one or more route modifications when the total hazard score exceeds a threshold; and
transmit the one or more route modifications to one or more computing devices to cause the one or more computing devices to indicate the one or more route modifications.

11. The non-transitory computer-readable media of claim 10, wherein the one or more route modifications are generated using real-time data.

12. The non-transitory computer-readable media of claim 11, wherein the real-time data includes at least one of weather data, traffic data, road conditions, traffic volume, severity of accidents, or environmental conditions.

13. The non-transitory computer-readable media of claim 10, wherein the driver-specific data includes at least one of speed relative to speed limits, driving distance from other vehicles, hard braking, and swerving.

14. The non-transitory computer-readable media of claim 10, wherein the one or more route modifications includes generating a navigational route that has a lower total hazard score than the total hazard score of the preliminary navigational route.

15. The non-transitory computer-readable media of claim 10, wherein the one or more computing devices indicate the one or more route modifications using a user interface.

16. A method comprising:
receive driver-specific data obtained using one or more sensors;
analyze the driver-specific data to identify one or more driving behaviors of a driver of a vehicle;
parse a preliminary navigational route into one or more road segments;
receive geocoded data associated with the one or more road segments;
generate a road segment hazard score for each of the one or more road segments by analyzing the geocoded data and the one or more driving behaviors;
generate a total hazard score using the road segment hazard score for each of the one or more road segments;
generate one or more route modifications when the total hazard score exceeds a threshold; and
transmit the one or more route modifications to one or more computing devices to cause the one or more computing devices to indicate the one or more route modifications.

17. The method of claim 16, wherein the one or more route modifications includes at least one of weather data, traffic data, road conditions, traffic volume, severity of accidents, or environmental conditions.

18. The method of claim 16, wherein the driver-specific data includes at least one of speed relative to speed limits, driving distance from other vehicles, hard braking, and swerving.

19. The method of claim 16, wherein the one or more route modifications includes generating a navigational route that has a lower total hazard score than the total hazard score of the preliminary navigational route.

20. The method of claim 16, wherein the one or more computing devices indicate the one or more route modifications using a user interface.
